(19) United States
(12) Patent Application Publication
(10) Pub. No.: US 2008/0191381 A1
(43) Pub. Date: Aug. 14, 2008

(54) Axial or conical spiral distributor for a blown film line and manufacturing method of a multilayered film

(75) Inventor: Jochen Hennes, Eschborn (DE)

Correspondence Address: COLLARD & ROE, P.C., 1077 NORTHERN BOULEVARD, ROSLYN, NY, 11576, US

(73) Assignee: KIEFEL EXTRUSION GmbH

(21) Appl. No.: 12/012,194

(22) Filed: Jan. 31, 2008

(30) Foreign Application Priority Data
Feb. 13, 2007 (DE) 10 2007 007 675.6
Jun. 22, 2007 (DE) 10 2007 029 310.2

(51) Int. Cl. B29C 47/06; B29C 47/14

(52) U.S. Cl. 264/173.16; 425/133.5; 264/171.1

(57) ABSTRACT

The invention relates to spiral distributors on axial or conical spiral blow heads.

The invention has discovered that when the circumference of a spiral flock in a spiral mandrel slot increases, it can be advantageous if the height of the spirals can be limited in such a manner that a similar surface covered with spirals is created in the twisted mandrel slots. The invention calls this surface “active surface”.

A plurality of aspects of the invention, which specify different rules regarding how to implement the basic observation, are presented.

### SUMMARY

The invention relates to an axial or conical spiral distributor for a blown film line and to a method for manufacturing a multilayered film.

Blown film lines are used to manufacture films. To this end, a thermoplastic material is molten and pressed through a ring slot nozzle. This nozzle lies horizontally, the molten mass issuing upwards through the ring slot nozzle. The resulting film tube continuously cools down while ascending and solidifies. At a certain height above the ring slot nozzle, after solidification, the film is laid flat and then coiled up.

Nowadays, films are often multilayered. In order to produce a multilayered film, several ring slot nozzles are disposed concentrically around each other in such a manner that a corresponding number of film tubes extend upwards inside each other and are there merged together. The molten mass flows of the different layers are mostly brought together before they exit towards the air.

The liquid thermoplastic material of each layer of film is pressed through a channel into a slot which then merges upwards into the ring slot nozzle. The entity in which the channels, slots and ring slot nozzles are configured is called a blow head. Corresponding ring slots are thus configured beneath the ring slot nozzles. Each single ring slot is called a spiral mandrel slot. Each spiral mandrel slot has a surface of the blow head on its radially inner and radially outer side. This surface delimitating the slot is called a spiral mandrel.

Let it be indicated that the surfaces of a spiral mandrel are shaped cylindrically when considering an axial spiral distributor. In a conical spiral distributor, the surfaces of a spiral mandrel have the shape of a cone shell.

In order to be able to blow out the molten mass in the most uniform manner, helical channels are inserted in the cylindrical or conically shaped surfaces of the spiral mandrels, which delimitate the spiral mandrel slot. These channels are called spirals.

On an unrolled cylinder surface, the spiral each extend approximately straight but are disposed at a sharp angle. On an unrolled cone shell however, the coils each extend helically around a central point of the unrolled cone, and are disposed in a sharp angle relative to a tangential direction.

Since in axial spiral distributors as well as in conical spiral distributors, the spirals extend helically across the surfaces of the spiral mandrels, namely either on one surface of a spiral mandrel or on both surfaces of a spiral mandrel, the molten mass spreads in a relatively homogeneous manner in the spiral mandrel slots by means of the spirals.

The spirals inside a spiral mandrel slot are called a “spiral flock” in the frame of this application.

When a smallest envelope is placed around the spiral of an unrolled spiral flock of a spiral mandrel slot, said envelope is as a rule rectangular, if a spiral flock of an axial spiral distributor is unrolled, or circular ring-shaped, if a spiral flock of a spiral mandrel slot on a conical spiral distributor is unrolled.

The surface surrounded by the smallest envelope is called an “active surface” in the frame of this application.

The document JP 56-67223 B shows an axial spiral distributor with four spiral mandrel slots. In each spiral mandrel slot, exactly one surface of a spiral mandrel is supplied with a spiral flock, the spiral being located respectively on the radially inside surface of three radially inner spiral mandrel slots. In a fourth spiral mandrel slot located radially outside, the spirals are disposed on the radially outer surface of the spiral mandrel slot.

For construction reasons, namely because of space requirements, the height of some of the active surfaces are variably configured. The active surfaces have been restricted in all such places where no more space was available. Thus, six spirals are cut and shown in the most inner spiral mandrel slot, only four spirals in the radially outside adjacent spiral mandrel slot, only three spirals in the radially outside adjacent spiral mandrel slot, again four spirals however in the radially most outer spiral mandrel slot, because a bend in the surface of the spiral mandrel only occurs relatively far above.

The U.S. Pat. No. 3,957,566 D1 shows a purely axial spiral distributor with two spiral mandrel slots that have an identically high active surface with respectively five cut spirals.

The document DE 203 07 412 U1 shows an axial spiral distributor with three concentric spiral mandrel slots, spirals being disposed radially inside and radially outside each spiral mandrel slot.

The U.S. Pat. No. 5,690,972 B shows a conical spiral distributor with spirals disposed identically on the surface located radially inside each spiral mandrel slot.

The document EP 1 055 504 A1 shows a spiral distributor with radially and conically shaped spiral mandrel slots, that are respectively constructed identically with regard to the spirals.

The document EP 0 051 358 A1 shows an axial spiral distributor in which the surfaces of the only spiral mandrel slot limiting said spiral mandrel slot can have varying heights. The print however does not address the spirals.

Other spiral distributors or blow heads are shown in the documents EP 0 061 935 A2 and JP 10-166424 B, in the U.S. Pat. No. 3,876,740 B, in the documents EP 1 116 569 B1 and DE 44 07 060 A1, in the U.S. Pat. No. 4,201,532 B or in the document JP 57-189820 B.

The object underlying the invention is to provide improved blow heads. This object is solved by the features of the independent claims. Advantageous designs can be inferred from the dependent claims.

According to a first aspect of the invention an axial or conical spiral distributor for a blown film line with an inner spiral mandrel slot with an inner spiral flock and with an outer spiral mandrel slot with an outer spiral flock solves the object of the invention, the envelope of the spiral flocks of the spiral mandrel slot defining an inner and an outer active surface, each outer active surface having a lesser height than at least a predominant number of inner active surfaces.

The observation underlying this aspect of the invention is that the radius and thus the circumference are greater with a spiral mandrel slot located radially outside than with a spiral mandrel slot located radially inside. In a constructive design according to the manner proposed by the first aspect of the invention, the height of the active surfaces tends to decrease continuously radially outward, in such a manner that it results in an at least equally big active surface in spite of the variable circumference of the spiral mandrels.

Tests by the inventor have shown that the convergence of the dimensions of the spiral mandrel surfaces results in a very uniform spreading of the molten mass and thus in a high quality of the film. Moreover, the guidance of the channels in a spiral mandrel during its technical development becomes easier when spiral mandrel slots located radially outside tend to take less height than spiral mandrel slots located radially inside.

A counter-example can be seen in the document JP 56-67223 B: the number of spirals per spiral mandrel slot—which corresponds approximately to the height of the active surface—on a course from radially inside to radially outside amounts to: 6, 4, 3, 4. Diverging from the rule proposed by the invention, the rule regarding the outer spiral mandrel slot thus is not carried out in the aforesaid print. The height of the active surface therein is merely smaller than the height of the most inner active surface. In the aforesaid print, the most outer active surface is identical with regard to the second active surface from the inside, the most outer surface being even bigger with regard to the second surface from the outside.

If in the aforesaid print, the most outer spiral mandrel slot were however configured in such a low manner that only three spirals were available, then the rule would be carried out.

Each outer active surface advantageously has a lesser height with regard to each inner active surface. This leads in other words to a geometry in which the heights of the active surfaces continuously decrease from radially inside to radially outside.

According to a second aspect of the invention, an axial or conical spiral distributor for a blown film line with an inner spiral mandrel slot having an inner spiral flock and with an outer spiral mandrel slot having an outer spiral flock solves the object of the invention, the envelope of the coil flocks of the spiral mandrel slot defining an inner and an outer active surface, the spiral distributor having active surfaces with variable heights, each outer active surface having an identical of lesser height with regard to each inner active surface.

According to the rule taught by this aspect of the invention, the height of the active surfaces decreases at least once but never increases on a course from radially inside to radially outside.

According to a third aspect of the invention, an axial or conical spiral distributor for a blown film line with an inner spiral mandrel slot having an inner spiral flock and with an outer spiral mandrel slot having an outer spiral flock solves the object of the invention, the envelope of the spiral flocks of the spiral mandrel slots defining an inner and an outer active surface, the spiral distributor having active surfaces with variable heights, each outer active surface having an identical or lesser height with regard to the adjacent inner active surface.

Such a rule leads to a geometry comparable to the one of the second aspect of the invention.

According to a fourth aspect of the invention, an axial or conical spiral distributor for a blown film line with an inner spiral mandrel slot having an inner spiral flock and with an outer spiral mandrel slot having an outer spiral flock solves the object of the invention, the envelope of the spiral flocks of the spiral mandrel slots defining an inner and an outer active surface, the outer active surface corresponding by its dimensions to the dimensions of the inner active surface, namely with a deviation of at most +/−30%, preferably of +/−20%, particularly preferably of +/−10%.

This aspect of the invention is also based on the observation that it is advantageous if the active surfaces at least substantially have the same height, although the radius and thus the circumference of each spiral mandrel slot increases radially outward.

It is to be understood that the comparison of the sizes of two active surfaces or generally of any of the active surfaces on a blow head according to the fourth aspect of the invention can be implemented advantageously in any variation of the single spiral mandrel slot that is related to the frame of the first three aspects of the invention, more specifically when the spiral distributor has active surfaces with different heights.

According to a fifth aspect of the invention, an axial or conical spiral distributor for a blown film line with an inner spiral mandrel slot having an inner spiral flock and with an outer spiral mandrel slot having an outer spiral flock solves the object of the invention, the envelope of the spiral flocks of the spiral mandrel slots defining an inner and an outer active surface, the outer spiral flock having different spiral patterns but the same spiral lengths as the inner spiral flock, namely with a deviation in length of at most +/−30%, preferably of +/−20%, particularly preferably of +/−10%.

The same observation underlies this aspect of the invention. It is furthermore based on the observation that it can make sense to configure the lengths of each spiral in a spiral mandrel slot located radially outside to be essentially of the same length. When appropriately designed, this can also lead to a very good homogenisation of the introduced molten mass.

It has already been explained that in a comparison of an active surface located radially inside with an active surface located radially outside, the height of the active surface located radially outside is preferably lesser.

It is more specifically proposed that the height of the outer active surface comprise at most 90%, preferably at most 80%, most preferably at most 70% of the height of the inner active surface.

According to a sixth aspect of the invention, a method for manufacturing a multi-layered film with a blown film line solves the object of the invention, a supply of the molten mass to an outer ring slot nozzle occurring through a lower outer spiral mandrel than a supply of the molten mass to an inner ring slot nozzle through an inner spiral mandrel, in order to create in both spiral mandrels an at least approximately similar active surface of spirals for spreading the molten mass.

The invention is more closely described in the following on the basis of an exemplary embodiment with reference to the drawings.

In the drawings:

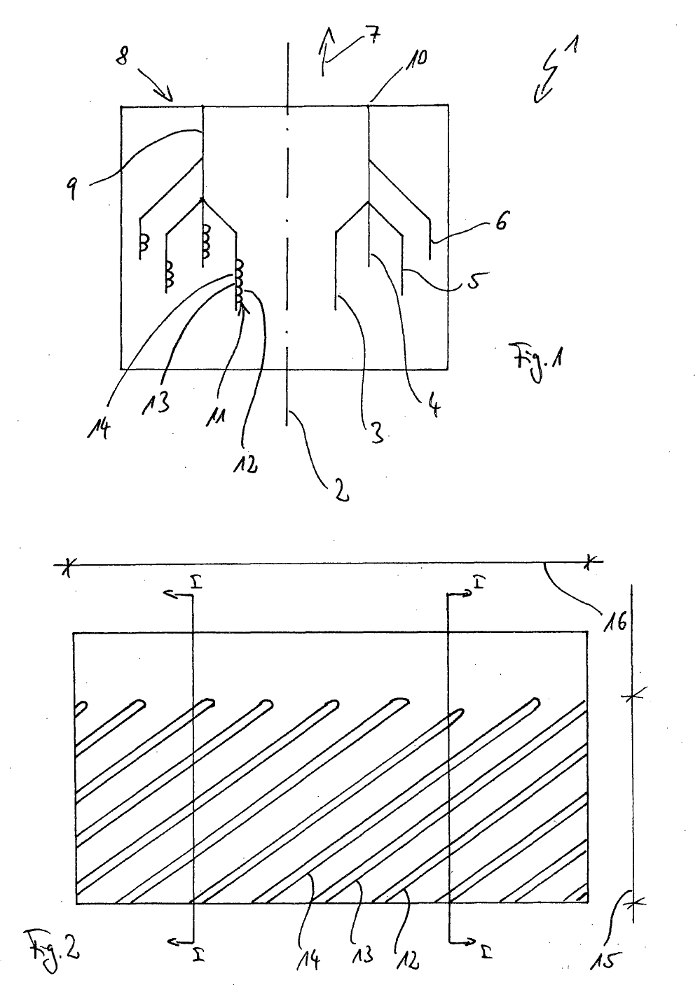

FIG. 1 a schematic section through an axial spiral distributor with four concentrical spiral mandrel slots disposed around each other and spirals respectively disposed on one side as well as

FIG. 2 a schematic of an unrolled radially most inner spiral mandrel slot of the blow head from FIG. 1.

The blow head 1 consists essentially of a plurality of ring-shaped elements placed around each other which form a connected channel structure between them. More specifically four spiral mandrel slots 3, 4, 5, 6—concentrically disposed around a longitudinal axis 2—are provided, which join on a course 7 toward an upper end 8 of the blow head 1 to form a ring slot 9 that flows into a ring slot nozzle 10.

When the blow head 1 is operating, molten plastic material for four film layers is fed into the four spiral mandrel slots 3, 4, 5, 6 respectively at their lower end 11 (exemplarily labelled). In the four spiral mandrel slots 3, 4, 5, 6, the molten plastic material flows upwards in a screw-shaped movement around the longitudinal axis 2 and thus spreads uniformly in the respective spiral mandrel slot.

In order to enforce or to assist the screw-shaped movement of the molten mass, spirals 12, 13, 14 (exemplarily numbered) are disposed in each spiral mandrel 3, 4, 5, 6.

The length of the spirals depends on the angle of the coils 12, 13, 14: depending on how close to each other they are disposed—with regard to the circumference of a spiral mandrel slot—, different overlaps of each single spiral occur in a section. With the increase of the distance between a spiral mandrel slot and the longitudinal axis 2, the height 15 of an active surface, a rectangular envelope around the spirals 12, 13, 14 in the shown example, decreases.

This leads to the fact that on the blow head 1, the four active surfaces of the four spiral mandrel slots 3, 4, 5, 6 almost have the same size although their circumference 16 significantly increases.

The invention has discovered that when the circumference of a spiral flock in a spiral mandrel slot increases, it can be advantageous if the height of the spirals can be limited in such a manner that a similar surface covered with spirals is created in the twisted mandrel slots. The invention calls theses surfaces “active surface”. A plurality of aspects of the invention, which specify different rules regarding how to implement the basic observation, are presented.

Inter alia, an active surface having the same size can lead to similar rinsing conditions of the molten mass even with different diameters of the spiral distributors. This can probably be explained inter alia by the fact that with active surfaces of at least approximately the same size having an appropriate design, similar wall shear stresses appear in the different spiral mandrels and/or thus allow for an at least approximately identical pressure reduction in the spiral mandrels.

1. An axial or conical spiral distributor for a blown film line with an inner spiral mandrel slot (3) having an inner spiral flock (12, 13, 14) and with an outer spiral mandrel slot (4, 5, 6) having an outer spiral flock, the envelope of the spiral flocks of the spiral mandrel slot defining an inner and an outer active surface, wherein each outer active surface has a lesser height (15) with regard to at least a predominant number of inner active surfaces.

2. The spiral distributor according to claim 1, wherein each outer active surface has a lesser height with regard to each inner active surface.

3. An axial or conical spiral distributor for a blown film line with an inner spiral mandrel slot having an inner spiral flock and with an outer spiral mandrel slot having an outer spiral flock, the envelope of the spirals flocks of the spiral mandrel slots defining an inner and an outer active surface, wherein the spiral distributor has active surfaces with different heights, each outer active surface having an equal or lesser height with regard to each inner active surface.

4. An axial or conical spiral distributor for a blown film line with an inner spiral mandrel having an inner spiral flock and with an outer spiral mandrel slot having an outer spiral flock, the envelope of the spiral flocks of the spiral mandrel slots defining an inner and an outer active surface, wherein the spiral distributor has active surfaces with different heights, each outer active surface having an equal or lesser height with regard to the adjacent inner active surface.

5. An axial or conical spiral distributor for a blown film line with an inner spiral mandrel having an inner spiral flock and with an outer spiral mandrel slot having an outer spiral flock, the envelope of the spiral flocks of the spiral mandrel slots defining an inner and an outer active surface, wherein the dimensions of the outer active surface corresponds to the dimensions of the inner active surface, namely with a variation of at most +/−30%, preferably of +/−20%, most preferably of +/−10%.

6. An axial or conical spiral distributor for a blown film line with an inner spiral mandrel having an inner spiral flock and with an outer spiral mandrel slot having an outer spiral flock, the envelope of the spiral flocks of the spiral mandrel slots defining an inner and an outer active surface, wherein the outer spiral flock has different spiral patterns but the same spiral lengths than the inner spiral flock, namely with a variation of at most +/−30%, preferably of +/−20%, most preferably of +/−10%.

7. The spiral distributor according to claim 1, wherein the height of the outer active surface corresponds to the height of the inner active surface multiplied by the quotient of an inner diameter to an outer diameter, namely with a variation of the ratio between the height and the quotient of at most +/−30%, preferably of +/−20%, most preferably of +/−10%.

8. The spiral distributor according to claim 1, wherein the height of the outer active surface is lesser.

9. The spiral distributor according to claim 1, wherein the height of the outer active surface comprises at most 90%, preferably at most 80%, most preferably at most 70% of the height of the inner active surface.

10. A method for manufacturing a multi-layered film with a blown film line, a supply of the molten mass to an outer ring slot nozzle occurring through a lower outer spiral mandrel than a supply of the molten mass to an inner ring slot nozzle through an inner spiral mandrel, in order to create in both spiral mandrels an at least approximately similar active surface of spirals for spreading the molten mass.
